(19) United States
(12) Patent Application Publication
(10) Pub. No.: US 2004/0083434 A1
(43) Pub. Date: Apr. 29, 2004

(54) System and method for selectively formatting and outputting handwritten notes and drawings

(76) Inventor: Catherine Fitch, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/280,669

(22) Filed: Oct. 24, 2002

(51) Int. Cl. G06F 17/00

(52) U.S. Cl. 715/541; 715/523

(57) ABSTRACT

A system and method for electronically transforming handwritten documents. The system includes a first mechanism for receiving a handwritten document and providing a signal in response thereto. A second mechanism allows a user to select a desired output format for the handwritten document. A third mechanism converts the handwritten document to the desired format based on the signal. In a more specific embodiment, the desired output format is an electronic file format selected to facilitate immediate printing or use by communications software or storage media. The second mechanism includes a user-interface that communicates with configuration software to allow a user to specify the desired output format and then to immediately print or send the resulting file to one or more predetermined locations. The user-interface includes a fourth mechanism to facilitate configuring the system to automatically select the desired format. The third mechanism includes a scanner module that automatically activates the user-interface, enabling a user to select the desired format. The third mechanism also provides an option to employ user-editable default formats for immediate printing or use with e-services. One or more file converters, including an image-to-vector based file converter for converting image file formats to vector-based file format, communicate with the user-interface or associated configuration module.

### BACKGROUND OF THE INVENTION

1. Field of Invention

This invention relates to electronic reproduction and conversion systems. Specifically, the present invention relates to systems and methods for selectively converting handwritten notes and drawings to electronic files to facilitate printing or electronic transfer.

2. Description of the Related Art

Reproduction systems, such as printers, scanners, and copiers are employed in various demanding applications including Optical Character Recognition (OCR), handwriting recognition, and data archival applications. Such applications often require versatile, multi-functional systems and devices that can accommodate various output formats required by different applications.

Versatile reproduction systems are particularly important in hand-writing recognition applications, where various output formats are often desirable. For example, certain applications require converting handwritten notes to typed notes to facilitate printing, emailing, storing, editing, and so on. Conventionally, to electronically convert handwritten notes to typewritten notes, a user employs a scanner, a computer running OCR software, and a printer connected to the computer and communicating with the OCR software via a driver. The user scans the handwritten notes, manipulates the notes via the OCR software, and then prints the notes via the printer. These steps are relatively time-consuming- and require expensive separate components, such as scanners, computers, and printers. Furthermore, hand-drawn sketches are often not properly converted by conventional OCR software resulting in illegible output.

To directly reproduce handwritten notes, copiers and mopiers often employed. Unfortunately, copiers, mopiers (mopiers are multi-function copiers), and photo printers often only perform direct copying. The copied notes are often hard copied, and consequently unusable for certain electronic applications. Copiers that store scanned input in an electronic file format typically do not allow users to select the file format to accommodate the demands of a given application. User output options are often limited to printing. Consequently, notes scanned by copiers, mopiers, or photo-printers are often difficult to electronically edit before printing or copying is performed.

To facilitate electronic editing and file transferring, electronic white boards are often employed. Electronic white boards scan notes written on the white board and store the results in an electronic file, typically in an image-based file format. Unfortunately, notes stored in these conventional image-based file formats are often not easily editable via word processing programs. Furthermore, scanned hand-drawn sketches are not easily editable via conventional vector-based drawing packages, such as Adobe Illustrator®, Microsoft Visio®, and Corel Draw®.

Hence, a need exists in the art for an efficient, flexible system and method for converting handwritten notes and drawings into desired file formats to facilitate outputting information, based on handwritten notes and sketches, to a printer, email package, CD writer, hard drive, and so on. There exists a further need for a system that can convert handwritten notes to an easily editable format, such as a text-based format for easy publishing, sending, or storing. There exists a further need for a system that can convert hand-drawn sketches to a vector-based format for easy editing in vector-based drawing programs.

### SUMMARY OF THE INVENTION

The need in the art is addressed by the system for electronically transforming a handwritten document of the present invention. In the illustrative embodiment, the inventive system is adapted for use with a printer, an all-in-one device, or a portable computer. The system includes a first mechanism for receiving a, handwritten document and providing a signal in response thereto. A second mechanism enables user-selection of a desired output format for the handwritten document. A third mechanism selectively converts the handwritten document to the desired format based on the signal.

In a more specific embodiment, the desired output format includes a standard file format for immediate printing or for use by communications software or storage media. The second mechanism includes a user-interface in communication with configuration software for allowing a user to specify the desired output format and then to immediately print or send the resulting file to one or more predetermined locations. A user may employ the user-interface to selectively pre-configure the system to automatically select the desired format. A user may also configure the system to prompt a user for the desired format or other configuration, information when the system is used.

In the illustrative embodiment, the third mechanism includes a scanning system that automatically activates the user-interface to enable a user to select the desired format. The third mechanism also provides an option to employ user-editable default formats for immediate printing or use with e-services. One or more file converters communicate with the user-interface and include an image-to-vector based file converter for converting image file formats to vector-based file formats.

The novel design of the present invention is facilitated by the second and third mechanisms, which enable a user to efficiently select a desired output format for scanned notes and sketches. Unlike conventional handwriting recognition systems, the third mechanism can convert both handwriting and sketches into predetermined desired formats for easy editing and publishing without requiring the use of a separate computer. The system of the present invention incorporates handwriting recognition and format conversion technology in an on-the-spot device with an accompanying simple user interface.

### BRIEF DESCRIPTION OF THE DRAWINGS

FIG. 1 is a diagram of a system for facilitating format conversion and output of handwritten notes and drawings via a publishing device constructed in accordance with the teachings of the present invention.

FIG. 2 is a more detailed diagram illustrating the publishing device of FIG. 1.

FIG. 3 is a flow diagram of a method adapted for use with the publishing device of FIG. 1.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

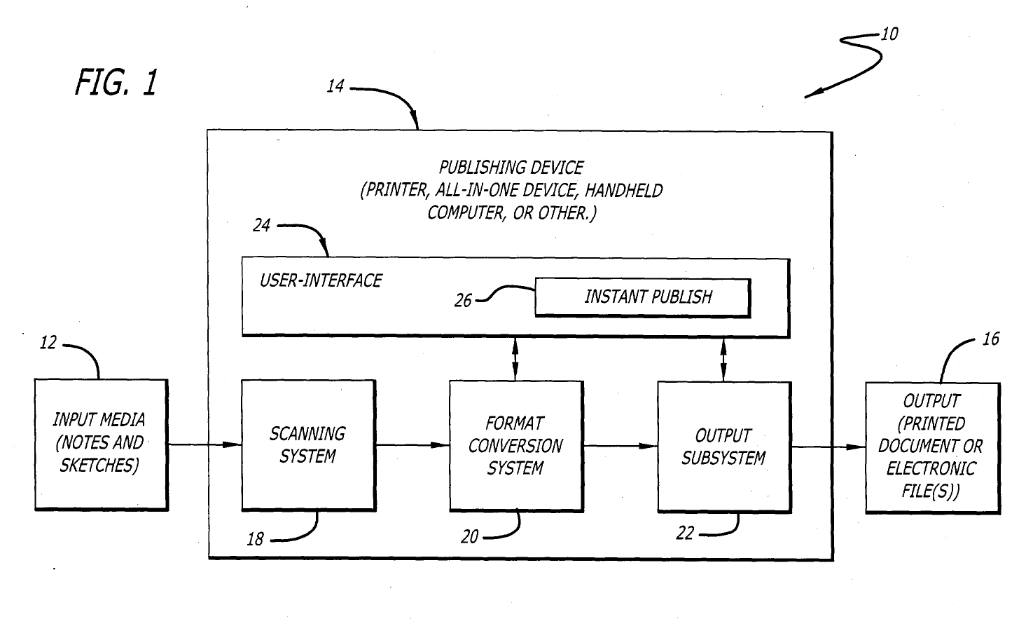

FIG. 1 is a diagram of a system 10 for facilitating format conversion and output of handwritten notes and drawings 12 via a publishing device 14 constructed in accordance with the teachings of the present invention. For clarity, various well-known components, such as operating systems, drivers, power supplies, and so on, have been omitted from the figures, however those skilled in the art with access to the present teachings will know which components to implement and how to implement them to meet the needs of a given application.

Input media 12, such as handwritten notes and hand-drawn sketches, is input to the publishing device 14, which converts the input media 12 into a predetermined desired format to provide corresponding output 16. The publishing device 14 includes a scanning system 18 that receives the input media 12. The scanning system 18 communicates with a format conversion system 20, which communicates with an output subsystem 22. A user-interface 24 communicates with the format conversion system 20 and optionally includes an instant publish button 26 to immediately activate automatic publishing of notes and/or sketches 12 inserted into the scanning system 18. The publishing device 14 may be implemented via a printer, an all-in-one device, a portable computer, and so on. Furthermore, the publishing device 14 may be replaced with a computer system that does not print or publish files, without departing from the scope of the present invention.

In operation, a user may employ the user-interface 24 to pre-configure the publishing device 14. When configuring the device 14 via the user-interface 24, the user provides configuration information specifying a desired output format for the input media 12. Alternatively, factory defaults may obviate the need to specify a desired output format. The output format of the output subsystem device 28 may be a typewritten and printed version of scanned input media, a printed vector-based computer drawing based on a hand-drawn sketch, a combination of the above, one or more computer files with a predetermined format incorporating a typewritten version of inserted notes and a vector-based version of handwritten drawings, and so on. After this configuration information is entered into the publishing device 14 via the user-interface 24, no additional configuration is required between uses unless the user opts for an alternative configuration. The configuration information input via the user-interface 24 is forwarded to format conversion system 20, which facilitates appropriate conversion of scanned notes and sketches in accordance with the configuration information.

When the publishing device 14 is configured as desired, the user inserts handwritten notes and sketches 12 into the scanning system 18 of the publishing device 14. The scanning system 18 scans the notes and sketches and provides a scanned file in response thereto to the format conversion system 20. The scanning system 18 provides an image-based file representing a scanned image of the notes and sketches. One, skilled in the art may readily modify a conventional scanner or build a new scanner to implement the scanning system 18 without undue experimentation. The scanning system 18 may be implemented via a conventional scanner without departing from the scope of the present invention.

The scanned image-based file is input to the format conversion system 20, which can selectively separate handwritten notes from hand-drawn sketches and convert the handwritten notes to typewritten text and the hand-drawn sketches to easily editable vector-based computer drawings in accordance with the configuration information. One skilled in the art may employ conventional modules, such as handwriting recognition modules, to implement the format conversion system 20, as discussed more fully below.

The format conversion system 20 performs predetermined format conversions (specified via the configuration information) on the scanned input file and provides an intermediate converted file to the output subsystem 22. The output subsystem 22 then either prints the document based on the converted file, forwards the file to an e-services system (which may handle email, fax, or other file communications), or forwards the file to a file system for storage and retrieval via document editing software or other software. The tasks performed by the output subsystem 22 on the intermediate file received from the format conversion system 20 depend on configuration information received via the user-interface 24.

In a preferred configuration, the publishing device 14 is configured so that notes and/or sketches 12 inserted into the scanning system 18 are automatically scanned. The handwritten notes are automatically converted to electronic typewritten text. Any sketches are converted to easily editable vector-based objects or files. The resulting file or files are then automatically printed or otherwise published.

Additional functions, such as automatically straightening jagged or wiggled lines in hand-drawn sketches may also be performed. This preferred configuration may be pre-stored in a configuration module and automatically activated upon pressing the instant publish button 26, as discussed more fully below. Alternatively, the instant publish button 26 may be used in place of a sensor built into the scanning system 18 for detecting when notes are inserted into the scanning system 18. In this case, the user presses the instant publish button 26 to indicate that notes have been inserted into the scanning system 18. Those skilled in the art will appreciate that additional automatic functions or operations may be performed on scanned sketches and notes, such as placing drawings or sketches on separate pages, separated from the notes, without departing from the scope of the present invention.

In an alternative exemplary configuration, the user is prompted via the user-interface 24 before each conversion operation is performed. The user is provided file conversion options based on e-services and printing options available via the publishing device 14. The sketches may be optionally left as image-based objects or files embedded in an intermediate file output by the format conversion system 20.

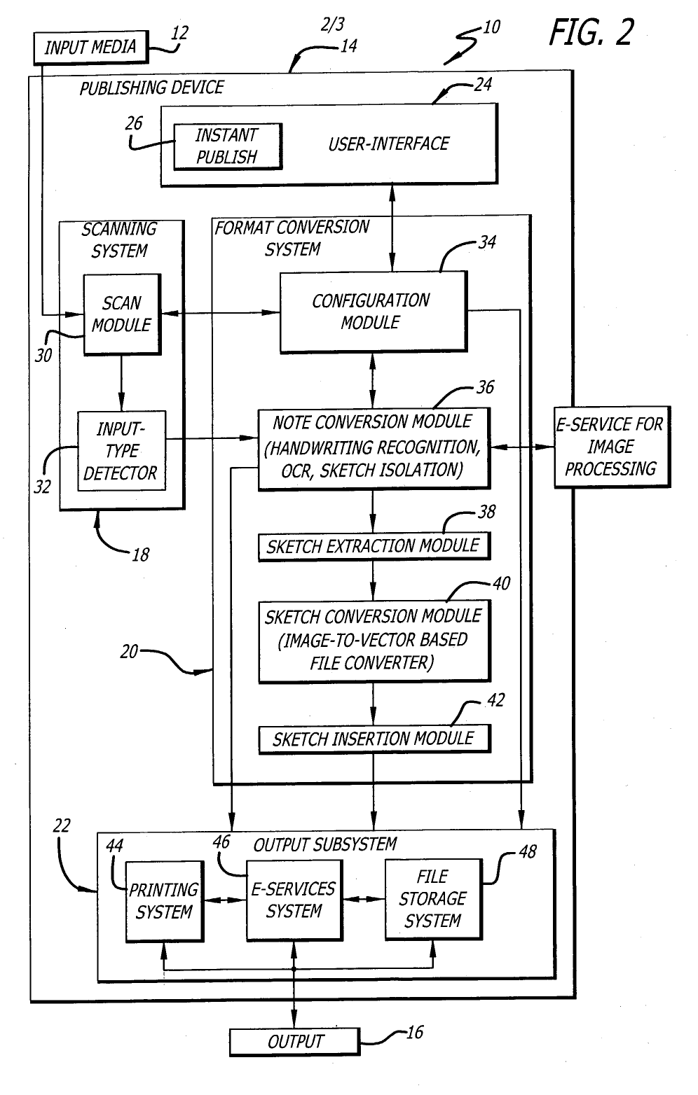

FIG. 2 is a more detailed diagram illustrating the publishing device 14 of FIG. 1. The scanning system 18 of the publishing device 14 includes a scan module 30 for receiving and scanning the input media 12 and an input-type detector 32 in communication with the scan module 30.

The format conversion system 20 includes a configuration module 34, a note-conversion module 36, a sketch-extraction module 38, sketch-conversion module 40, and a sketch-insertion module 42. The configuration module 34, which stores and relaying configuration information input via the user-interface 24, communicates with the scan module 30 of the scanning system 18, the user interface 14, the note-conversion module 36, and the output subsystem 22. The note-conversion module 36 receives input from the input-type detector 32 and selectively provides output directly to the output subsystem 22 and/or to the sketch-extraction module 38. Those skilled in the art will appreciate that the note-conversion module 36 may receive input directly from the scan module 30 instead of from the input-type detector 32, without departing from the scope of the present invention. The output of the scan module 30 may pass straight through the input-type detector 32 without activating the input-type detector 32 detection mechanisms if the scanning module 18 is so configured.

The sketch-extraction module 38 provides output to the sketch-conversion module 40, which provides output to the sketch-insertion module 42. The sketch-insertion module 42 provides output to the output subsystem 22. The output subsystem 22 includes a printing system 44, an e-services system 46, and a file storage system 48, which intercommunicate and provide output 16. All the modules 34-42 in the format conversion system 20 can be augmented with e-service available additional modules. This allows for flexibility and upgradeability of the conversion functionality.

In operation, a user configures the publishing device 14 via user-interface 24, which may include various buttons, or other input devices, such as computer mice and/or keypads. The exact details of the user-interface 24 are application-specific and may be readily determined and constructed by one skilled in the art to meet the needs of a given application.

Configuration information input via the user-interface 24 may specify options such as preferred file types for files containing text corresponding to handwritten characters; preferred file types or embedded object types for scanned sketches; scanning preferences, such as automatic scanning upon detection of input media placed in the scanning system. 18; and output preferences, such as whether to print or email converted notes. Such configuration is also possible from remote software interfaces such as Embedded Web Server, Web JetAdmin, or similar administrative tools. This frees administrators from physically visiting each device and supports configuration of multiple devices simultaneously. Configuration information is maintained via the configuration module 34 and selectively accessed by the scan module 30, the conversion module 36, and the output subsystem 22.

In an exemplary configuration, the user inserts notes into the scan module 30, which has been configured, via the user-interface 24 and configuration model 34, to automatically scan input media upon insertion of the input media 12 into the scan module 30. A resulting scanned image-based file is then provided to the input-type detector 32. With reference to the scanned image-based file, the input-type detector 32 determines if the input media 12 represents handwritten notes and/or drawings. One skilled in the art may develop the input-type detector 32 without undue experimentation.

The scan module 30 includes an optical or mechanical sensor (not shown) that detects when input media is inserted into the scan module 30 and generates a detection signal in response thereto. The detection signal activates software running on the scan module 30 that controls the behavior of the scan module 30 in accordance with configuration information maintained in the configuration module 34 of the format conversion system 20. Alternatively, the instant publish button 26 may be employed instead of or in addition to the optical or mechanical sensor.

If the scanned input does not represent handwritten notes or drawings, then the input-type detector 32 forwards the scanned file to another module, such as the file storage system 48 in the output subsystem 22, thereby bypassing the format conversion system 20. In an alternative configuration, the functionality of the input-type detector 32 is bypassed, and all scanned inputs are transferred to the format conversion system 20. In this alternative configuration, a scanned photograph, for example, may be converted to a predetermined file type other than the default file type output by the scanning system 18, such as a Bitmap file (BMP) or a Graphic Image File (GIF) format, before transfer to the pre-selected module (indicated by the configuration information) of the output subsystem 22.

In the original exemplary configuration, notes and/or sketches input to the note-conversion module 36 are converted to typewritten text and/or vector-based graphics, respectively, via the format conversion system 20. The vector-based graphics may be files or other object types that are embedded into a selected intermediate format, such as Microsoft Word® (MS Word) WordPerfect®, and so on. If the output file is selected to be an MS Word file, hand-drawn sketches are embedded in the document as MS Word drawing objects, which are vector-based objects.

In the present specific embodiment, the note-conversion module 36 converts handwritten notes to typewritten text via handwriting recognition software, and avoids processing sketches, leaving the sketches embedded in the resulting file as image-based objects. The sketch extraction module 38 extracts the image-based objects from the file that is output from the note-conversion module 36. The extracted objects are either converted to separate files or left as objects by the sketch-conversion module 40. If the publishing device 14 is configured to extract objects corresponding to hand-drawn sketches from the scanned file, the extracted objects are stored in separate files, such as vector-based files or image-based files, while the handwritten characters are then preferably stored in a separate text-based file.

The sketch-conversion module 40 converts the extracted objects or files corresponding to hand-drawn sketches and converts them to a vector-based drawing format, easily editable via drawing software, such as Corel Draw®, Adobe Illustrator®, or MS Word, Visio®, and so on. The exact type of vector-based format and whether the sketches are re-inserted into the same file as the handwritten text or saved in a separate file is application-specific and may be controlled by a user via the user-interface 24. In an alternative configuration, the note-conversion module 36 is configured to apply hand-writing recognition software to the scanned input file and forward the results directly to the output subsystem 22, avoiding processing via the sketch-processing modules 38, 40, and 42.

If the extracted and converted sketches are to be embedded into the file, the file containing the text (minus the sketches) and the converted sketches are input to the sketch-insertion module 42, which inserts the images into their original locations into the file containing the text. The converted vector-based sketches may be inserted into other locations, such as at the beginning or the end of the text-containing file, without departing from the scope of the present invention.

Various software modules for converting image-based objects and files to vector-based drawing and files are known in the art and may be employed by one skilled in the art to implement the present invention without undue experimentation.

The output (intermediate file) of the format conversion system 20 is passed to the output subsystem 22, which behaves according to configuration information contained in the configuration module 34. If the user has configured the output subsystem 22 to automatically print all processed notes and sketches, then the intermediate file is forwarded to the printing system 44, which prints the document, thereby providing the output 16. Alternatively, the output subsystem 22 may be configured to forward the intermediate file to the e-services system 46 in preparation for publishing via file transfer techniques, such as email or fax, or to the file storage system 48. A user may later access the file storage system via the user-interface 24 and enable use of the stored file by other modules 44 and 46 in the output subsystem 22.

Furthermore, the user may configure the publishing device 14, via the user-interface 24, to automatically select a desired or default output format based on chosen e-services or other criteria. The user-interface 24 and configuration module 34 may also be employed to pre-configure the publishing device 14 to prompt a user for the desired format or other configuration information each time the publishing device 14 is used. The scan module 30 may automatically activate the user-interface 24 and accompanying software to enable the user to select the desired format. The user-interface 24 may provide an option to employ user-editable default formats for immediate printing or use with c-services provided by the c-services system 46.

In the preferred embodiment, the format conversion system 20 is implemented in software running on a computer (not shown) installed in the publishing device 14. The c-services system 46 may be implemented via an embedded web server.

Hence, the publishing device 14 allows a user to select an output file format and then immediately print, send, or store the resulting file. The selection may be performed by pre-configuring the device 14 via the user-interface 24 or by causing the user-interface 24 to prompt the user for configuration information when needed. In the case where the user is prompted via the user-interface 24, the scan module 30 automatically activates the user-interface software 24, enabling the user to select a desired output format, such as printed output or emailed file.

Configuration information maintained via the configuration module 34 affects file converters running in the note-conversion module 36 and the sketch-conversion module 40. The file converters implemented in the sketch-conversion module 40 include an image-to-vector based file converter for converting image file formats, such as GIF, TIFF, BMP, JPEG, and so on to vector based formats, such as Adobe Illustrator® or Corel Draw® Files. Such file type converters are known in the art.

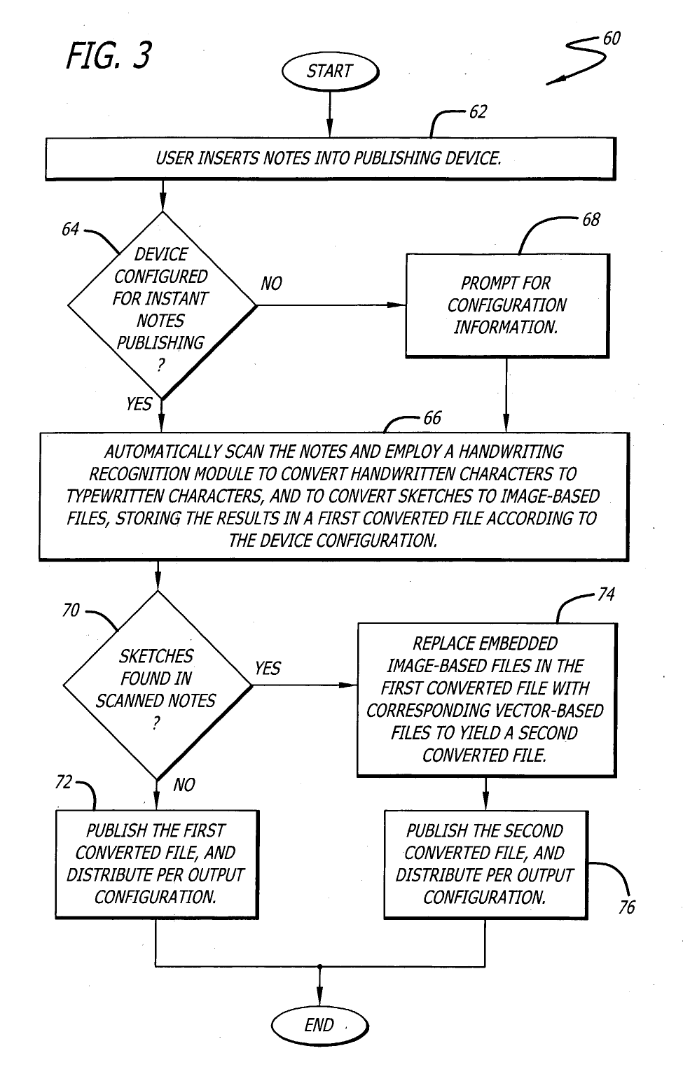

FIG. 3 is a flow diagram of a method 60 adapted for use with the publishing device 14 of FIGS. 1 and 2. With reference to FIGS. 2 and 3, in an initial insertion step 62, a user inserts handwritten notes and/or drawings (sketches) into the scanning system 18 of the publishing device 14.

In a subsequent configuration-determination step 64 the scanning system 18 determines, with reference to configuration information in the configuration module 34, whether the publishing device 14 has been pre-configured for instant notes publishing. If the publishing device 14 has been configured for instant notes publishing, control is passed to an automatic scanning step 66. Otherwise, control is passed to a configuration-prompting step 68.

In the configuration-prompting step 68, the user is prompted for configuration information via the user-interface 24 as requested by the scan module 30 of the scanning system 18. Control is then passed to the automatic-scanning step 66.

In the automatic-scanning step 66, the scanning system 18 automatically scans notes and/or sketches inserted into the scan module 30. Handwriting recognition software running on the note-conversion module 36 converts handwritten characters in the scanned notes into typewritten characters. The handwriting recognition software employs sketch-determination software to help avoid applying character-recognition algorithms to sketches. Any sketches remain in original scanned image-based format in a first converted file, which also includes the typewritten characters.

In a subsequent sketch-determining step 70, the note-conversion software determines if any sketches are included in the scanned input. If sketches are included, then control is passed to a sketch-formatting step 74. Sketches remain in original scanned image-based format until they are extracted and converted into vector-based objects or files via the sketch-processing modules 38, 40, and 42 in the sketch-formatting step 74. In the present embodiment, the resulting file (second converted file) includes typewritten characters corresponding to handwritten notes and embedded vector-based files or objects corresponding to hand-drawn sketches. Hence, the sketch-formatting step 74 involves extracting embedded image-based files (representing sketches) from the first converted file, converting the image-based files to vector-based files, and then replacing embedded image-based files in the first converted file with the corresponding vector-based files to yield a final converted file.

If in the sketch-determining step 70, no sketches are found, then control is passed to a first publishing step 72, where the first converted file is printed, published, and/or stored electronically. Otherwise, control is passed to a second publishing step 76, where the second converted file is printed, published, and/or stored electronically.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

Accordingly,

What is claimed is:

1. A system for electronically transforming handwritten documents comprising:
first means for receiving a handwritten document and providing a signal in response thereto;
second means for enabling user-selection of a desired output format for said handwritten document; and
third means for selectively converting said handwritten document to said desired format based on said signal.

2. The system of claim 1 wherein said desired output format includes a standard file format for immediate printing or for use by communications software or storage media.

3. The system of claim 2 wherein said second means includes a user-interface in communication with configuration software for allowing a user to specify said desired output format and then to immediately print or send the resulting file to one or more predetermined locations.

4. The system of claim 3 wherein said user-interface includes fourth means for selectively pre-configuring said system to automatically select said desired format and for selectively pre-configuring said system to prompt a user for said desired format or other configuration information each time said system is used.

5. The system of claim 4 wherein said third means includes a scanning system that automatically activates said user-interface to enable a user to select said desired format and that provides an option to employ user-editable default formats for immediate printing or use with e-services.

6. The system of claim 5 further including one or more file converters in communication with said user-interface.

7. The system of claim 6 wherein said one or more file converters include an image-to-vector based file converter for converting image file formats to vector-based file formats.

8. The system of claim 7 wherein said system is implemented in a printer or a portable computer, such as a Personal Digital Assistant (PDA).

9. A system for automatically converting handwritten notes or sketches to one or more desire formats comprising:
first means for detecting handwritten notes and/or sketches and providing a signal in response thereto;
second means for receiving user-configuration information;
third means for selectively automatically scanning said handwritten notes and/or sketches based on said signal and providing a scanned version in response thereto; and
fourth means converting scanned version to a predetermined output format specified by said user-configuration information.

10. The system of claim 9 wherein said one or more desired formats includes printed output or one or more desired electronic file formats.

11. The system of claim 10 wherein said one or more desired electronic file formats includes a text-based file format, and/or a vector-based drawing file format.

12. The system of claim 11 wherein said printed output represents a typewritten and printed version of said handwritten note and/or sketch.

13. The system of claim 12 wherein said fourth means includes means for separating said handwritten notes and/or sketches into handwritten text and hand-drawn sketches.

14. The system of claim 13 wherein said one or more desired file formats includes said text-based file format for handwritten text and said vector-based file format for hand-drawn sketches.

15. The system of claim 14 wherein said fourth means includes means for combining said handwritten text in said text-based file format and said hand-drawn sketches in said vector-based format into a single easily-editable file.

16. The system of claim 15 wherein said easily editable file is a Microsoft Word® file.

17. The system of claim 9 wherein said first means includes a module having a mechanism for determining when media has been inserted into said module.

18. The system of claim 17 wherein said first means further includes a scanning system for scanning a portion of said handwritten notes and/or sketches and an input type detection system in communication with said scanning system for automatically detecting if said media represents said handwritten notes and/or sketches and providing said signal in response thereto.

19. The system of claim 18 wherein said first means includes configuration software running on said system, said software including means for selectively bypassing input type detection and adjusting said signal to indicate that all media inserted into said tray represents said handwritten notes and/or sketches in response to predetermined user-configuration information obtained via said second means.

20. The system of claim 19 wherein said second means includes a user-interface in communication with said configuration software, said user-interface including an instant publish button to trigger automatic conversion of said scanned version into a preset format.

21. The system of claim 20 wherein said user-interface and software include means for establishing said preset format by selecting from available formats within the capabilities of said fourth means.

22. The system of claim 21 wherein said available formats are established based on available e-services and output functionality of said device within which said system is installed.

23. The system of claim 22 wherein said device is a printer having means for providing c-services.

24. The system of claim 23 wherein said fourth means includes a converter for converting an image-based file format of said scanned version to a text-based format for handwritten text and to a vector-based file format for drawings.

25. The system of claim 24 wherein said converter includes Optical Character Recognition software for converting text stored in said image-based file format into a text-based file format.

26. A system for automatically converting handwritten notes or sketches to one or more desire formats comprising:
a scanning system that detects handwritten notes and/or sketches and provides a signal in response thereto;
a user interface that receives user-configuration information and communicates with the scanning system;
software that automatically activates the scanning system to scan said handwritten notes and/or sketches based on said signal and provide a scanned version of the handwritten notes and/or sketches in response thereto; and
a format converter that converts said scanned version to a predetermined output format specified by said user-configuration information.

27. A method for electronically transforming handwritten documents comprising the steps of:
receiving a handwritten document and providing a signal in response thereto;
enabling user-selection of a desired output format for said handwritten document; and
converting said handwritten document to said desired format based on said signal.
